(19) United States
(12) Patent Application Publication
(10) Pub. No.: US 2017/0239907 A1
(43) Pub. Date: Aug. 24, 2017

(54) MACHINE FOR THE PRODUCTION OF CARDBOARD TUBES

(71) Applicant: FUTURA S.P.A., Capannori (LU), Fraz. Guamo (IT)

(72) Inventor: Fabio PERINI, Viareggio (LU) (IT)

(21) Appl. No.: 15/512,747

(22) PCT Filed: Sep. 17, 2015
(86) PCT No.: PCT/IT2015/000233

§ 371 Date: Mar. 20, 2017

(30) Foreign Application Priority Data
Oct. 29, 2014 (IT) FI2014A000243

(51) Int. Cl. B31C 3/00

(52) U.S. Cl. CPC B31C 3/00

(57) ABSTRACT

Machine for the production of cardboard tubes, comprising a mandrel (M) on which a cardboard tube (T) is formed by the helicoidal winding of a cardboard strip (S) on said mandrel (M); a winding member (WB) adapted to interact with the mandrel (M) and the cardboard strip (S) to realize said helicoidal winding, an inlet section for drawing-in the cardboard strip (S); dragging means adapted to drag the cardboard strip (S) introduced in said inlet section, along a predetermined dragging direction (TD), said dragging means being active during a drawing-in step; cutting means for configuring the cardboard strip (S) in a configuration suitable for winding it on the mandrel (M); and guide means adapted to guide the cardboard strip (S) towards the mandrel (M) at the end of said drawing-in step, said guide means being disposed and acting between the dragging means and the mandrel (M).

The present invention relates to a machine for the production of cardboard tubes.

More particularly, a machine according to the present invention is destined to the production of tubes by helical winding of cardboard stripes.

It is known that the machines used for making cardboard tubes comprise a forming mandrel on which the cardboard stripes are wound after the distribution of a predetermined amount of glue on them. A winding belt, that forms a helical turn around the mandrel, causes the cardboard stripes to wind helically around the same mandrel and causes the advancing of the forming tube along the external surface of the latter. The same belt presses the cardboard stripes against the mandrel, in correspondence of said helical turn, facilitating their glueing. The winding belt is guided by two pulleys, one of them being a driving pulley. The winding belt, the guiding pulleys and the electric motor to which the driving pulley is connected, are mounted on a support whose position in relation to the mandrel can be adjusted to adjust the orientation of the cardboard turns in relation to the axis of the mandrel. Cutting means are provided, to cut the tube into elements having a given length. A machine of this kind is disclosed, for example, by EP1631425.

When the machine must be started, and every time the production must be re-started after an interruption, an operator must insert a front edge of each cardboard stripe between the winding belt and the mandrel, driving the machine in the <<jog>> mode. This operation, commonly said <<drawing-in>>, requires the intervention of a skilled operator and is dangerous because the operator is obliged to access exposed parts of the machine and there is the risk that the arms or the hands of the operator are caught by the belt turns or between the mandrel and the winding belt. The present invention aims at eliminating, or at least greatly reducing, the aforementioned drawbacks. This result is achieved, according to the present invention, by providing a machine having the features indicated in claim 1. Other features of the present invention are the subject of the dependent claims. With a machine according to the present invention it is possible to automate a considerable part of the drawing-in process, avoiding the risk that an arm or the clothes of the operator are caught by the winding belt, thus increasing the safety level of the tube-forming machine, and allowing the execution of a faster threadening step. Moreover, a drawing-in mechanism according to the present invention can be easily used also by not particularly skilled operators. Another advantage lies in that a drawing-in mechanism according to the present invention is relatively simple from a mechanical point of view and can be mounted also on existing tube-forming machines. It is also possible to modify the direction along which the cardboard stripes are cut in order to obtain, when desired, cardboard tubes whose front part is substantially orthogonal to the mandrel axis so as to reduce the scraps.

These and other advantages and features of this invention will be best understood by anyone skilled in the art thanks to the following description and to the attached drawings, provided by way of example but not to be considered in a limiting sense, in which:

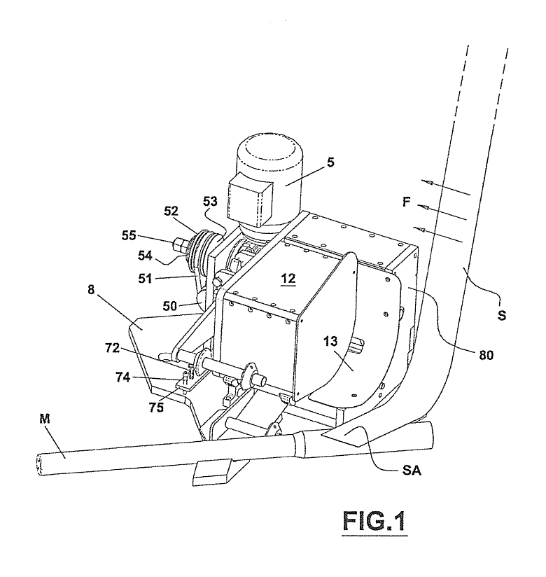

FIG. 1 is a schematic perspective view of a machine according to the present invention, wherein the winding belt is not shown to make the mandrel anc the output section of the drawing-in mechanism better visible;

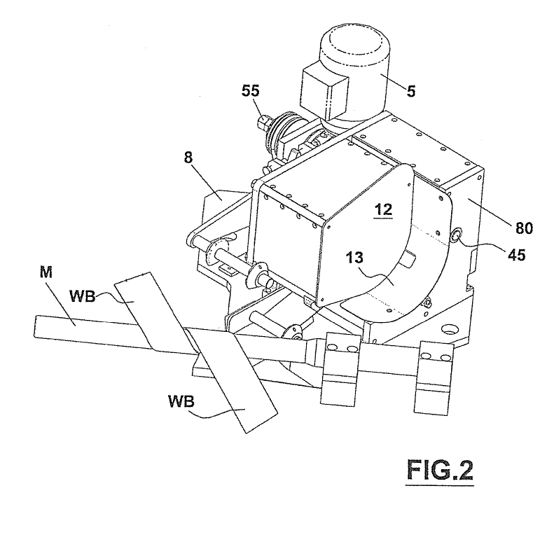

FIG. 2 is similar to FIG. 1 but here a part of the winding belt is shown and the cardboard stripe is not shown;

FIG. 1 shows the machine of FIG. 1 with the protection carter and the side guide plate removed;

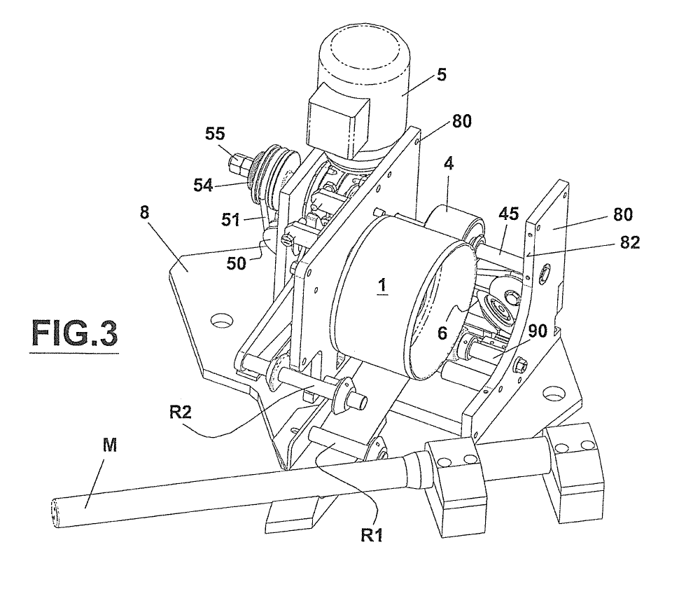

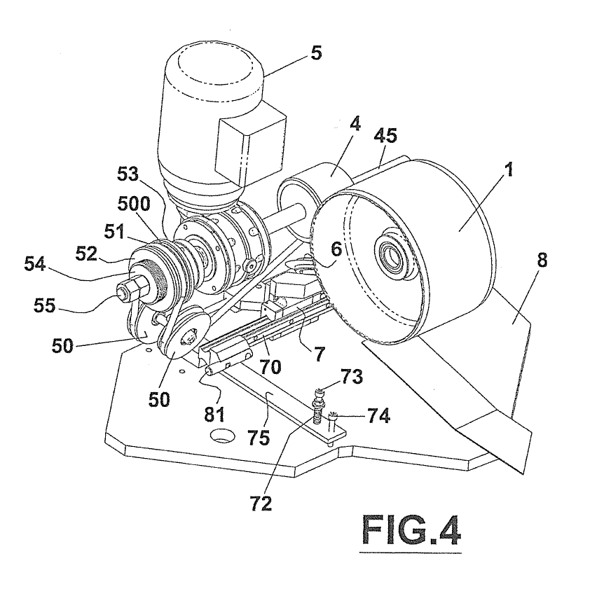

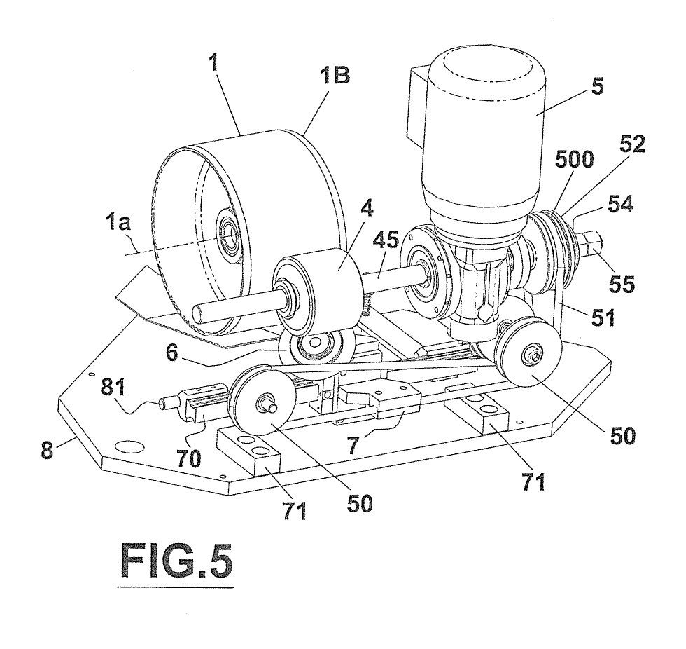

FIGS. 4 and 5 are two perspective views of the unit shown in FIG. 1 with removed parts to better show the blade-holding unit and the related transmission;

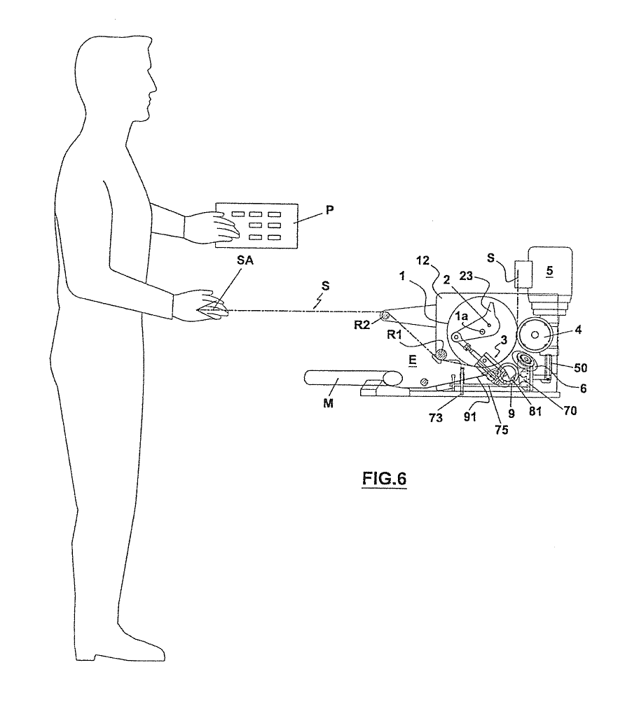

FIG. 6 is a schematic transparency side view of a machine according to the present invention in a step of preparation of a cardboard stripe to the drawing-in operation;

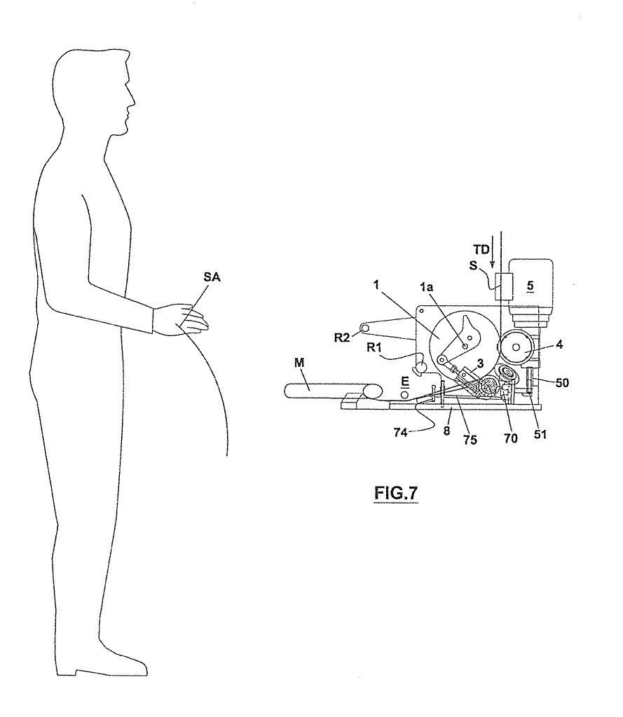

FIG. 7 is similar to FIG. 6 but it shows a step of cutting the cardboard stripe;

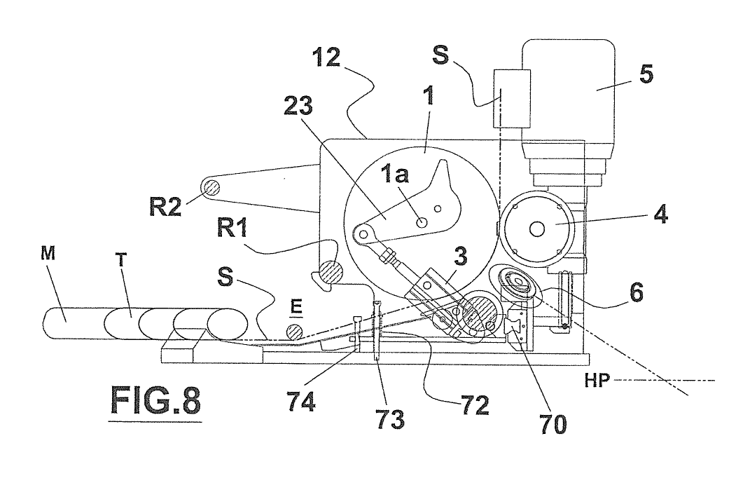

FIG. 8 is similar to FIGS. 6 and 7 but it shows the production of a cardboard tube;

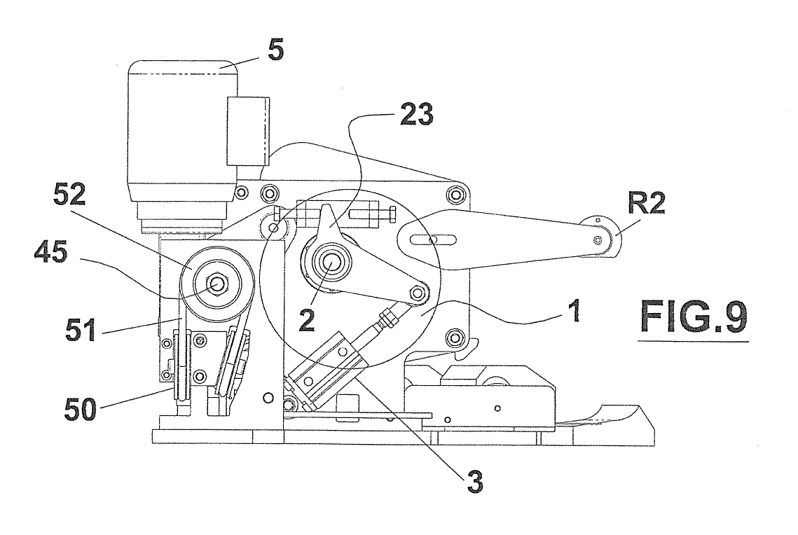

FIG. 9 is a side view of the machine shown in FIG. 1 without the representation of the mandrel;

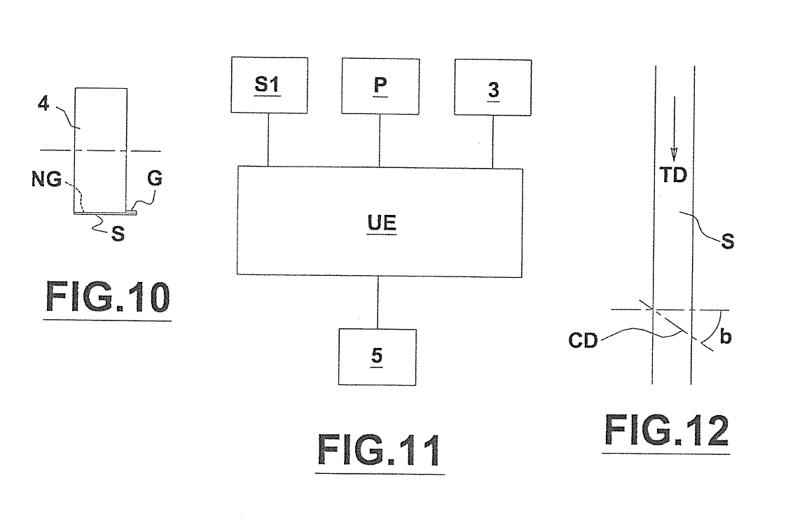

FIG. 10 schematically shows the position of the friction wheel (4) in relation the cardboard stripe (S) while the latter is dragged by the same friction wheel;

FIG. 11 is a simplified block diagram showing a possible programmable control system for controlling a machine according to the present invention;

FIG. 12 is a scheme showing a possible orientation of a cutting line (CD);

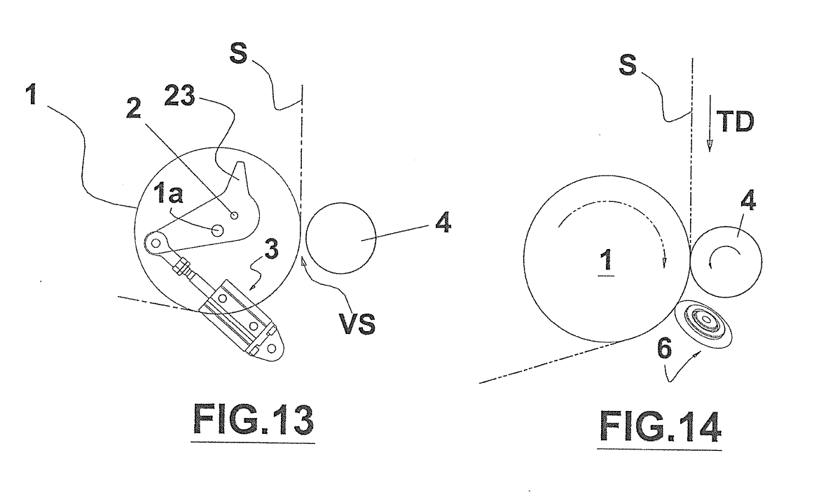

FIG. 13 is an enlarged detail of FIG. 6;

FIG. 14 is an enlarged detail of FIG. 7;

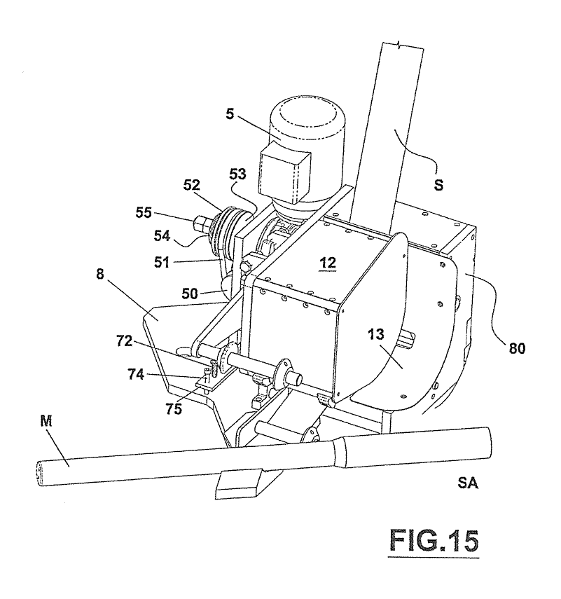

FIG. 15 shows an alternative embodiment of the unit shown in FIG. 1 that illustrates the possibility of inserting a cardboard stripe from the above instead of from a side;

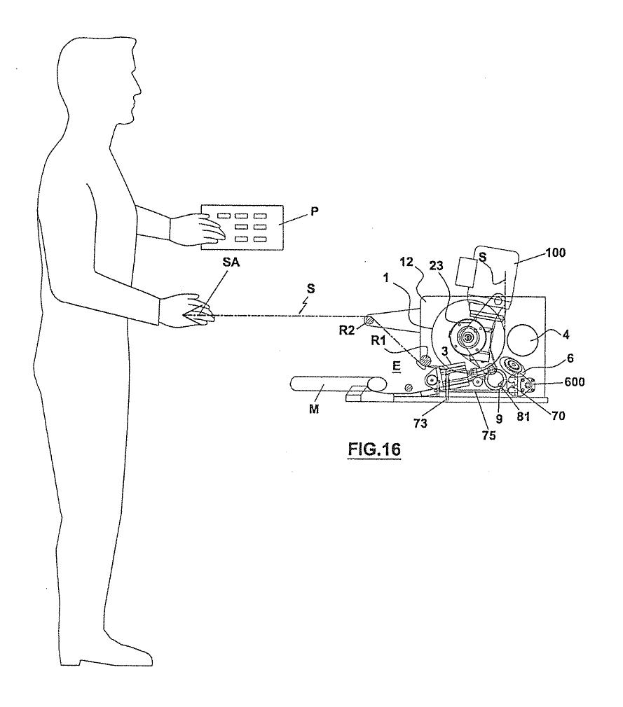

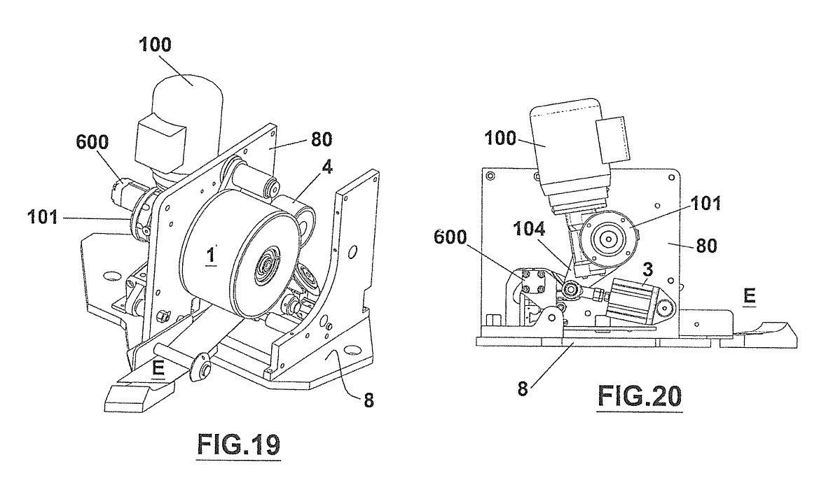

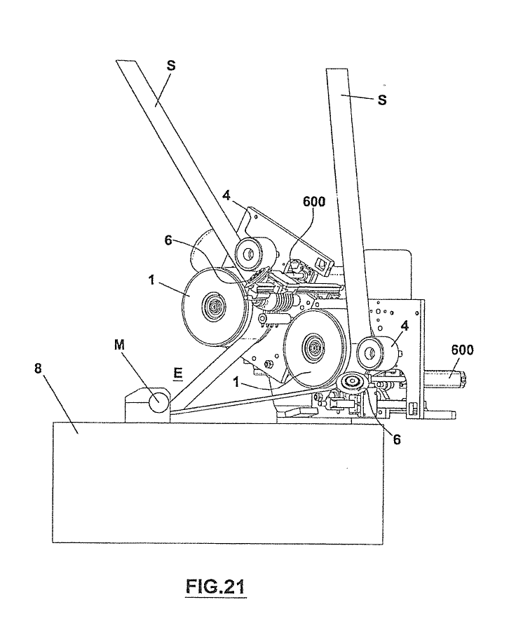

FIGS. 16-20 show another embodiment of the present invention;

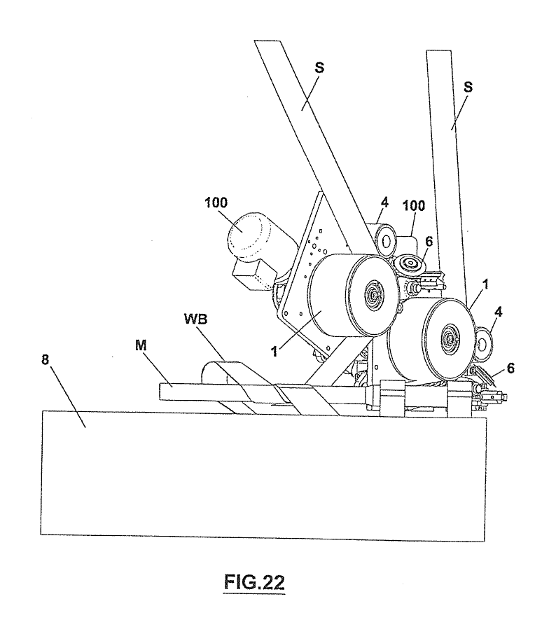

FIGS. 21-23 show yet another embodiment of the present invention.

Reduced to its basic structure and with reference to the attached drawings, a tube-forming machine according to the present invention is of the type comprising a mandrel (M) on which it is formed a cardboard tube (T) by helical winding of a cardboard stripe (S) around the same mandrel (M) by means of a winding belt (WE). The latter features a part helically wound on the mandrel (M) and is operated by a corresponding electric motor (not shown in the drawings). With this machine it is executed a drawing-in step, consisting in arranging the cardboard stripe (S) in a suitable configuration to obtain its winding on the mandrel (M), and a subsequent forming step, consisting in said winding of the cardboard stripe (S) to form the tube (T). Since along a side edge of the cardboard stripe (S) is applied a given amount of glue (G), the cardboard turns formed on the mandrel (M) as a consequence of the dragging action exerted by the winding belt (WB) are glued to each other.

A tube-forming machine according to the present invention comprises an inlet section, preferably on a side of the machine, for the cardboard stripe to be drawn-in; dragging means, adapted to drag the cardboard stripe (S), previously inserted in said inlet section, along a predetermined dragging direction (TD), said dragging means being activated during the drawing-in step and deactivated during the forming step; and guiding means, adapted to guide the cardboard stripe (S) towards the mandrel (M) at the end of said drawing-in step, said guiding means being disposed and acting between the dragging means and the mandrel (M).

Preferably, as further disclosed below, a tube-forming machine according to the present invention also comprises cutting means, adapted to cut the cardboard stripe (S) along a cutting direction that forms a predetermined angle in relation to the dragging direction at the end of the drawing-in step.

According to the example shown in the drawings, the machine features an idle wheel (1), whose axis is denoted by reference numeral 1a, having a side base (1B) where a transverse eccentric pin (2) is applied. The latter is connected with a pneumatic cylinder (3) by a rod (23). The machine also comprises a friction wheel (4) connected with a motor gear (5) through a shaft (45). The idle wheel (1) and the friction wheel (4) are in a counter-facing relationship, i.e. they positioned such that the respective external surfaces are opposite to each other as shown in the drawings. The axis of the friction wheel (4) is fixed. The eccentric pin (2), the axis (1a) of the idle wheel (1) and the axis of the friction wheel (4) are orthogonal to the sheet in FIG. 6, FIG. 7 and FIG. 8. The pneumatic cylinder (3) allows the positioning of the idle wheel (1) on a first position spaced from the friction wheel (1), as shown in FIG. 7, and a second position in which its external surface is pressed against the external surface of the friction wheel (4) and the wheels (8) disclosed below. The first position is the position of the idle wheel (1) when the cardboard stripe (S) is inserted into the machine. The second position is the position of the wheel (1) when the cardboard stripe (S) is dragged as further disclosed below. In practice, the pneumatic cylinder (3) is a device adapted to move the idle wheel (1) between said two positions.

According to the example shown in the drawings, the machine further comprises a blade (6) inclined with a predetermined angle in relation to a generic horizontal plane (HP). The blade (6) is used, as further disclosed below, to cut the cardboard stripe (S) along a cutting direction (CD) that forms an angle (b) with respect to the dragging direction (TD) at the end of the drawing-in step. Said blade (6) si mounted on a carriage (7) that is connected with said motor gear (5) through a transmission (50, 500, 51). The carriage (7) runs along a guide (70) oriented parallel to the axes of the pin (2), the idle wheel (1) and the friction wheel (4). Through said transmission (50, 500, 51), the motor gear (5) moves the carriage (7), with the blade (6), parallel to the axes of the pin (2), the idle wheel (1) and the friction wheel (4). The blade (6) and the carriage (7) are positioned below the idle wheel (1) and the friction wheel (4). As said above, the carriage (7) that supports the blade (6) is driven by the motor gear (5) through the transmission (50, 500, 51). The latter comprises a plurality of pulleys (50 on which is wound the belt (51). As particularly shown in FIGS. 4 and 5, one of these pulleys (500) is applied on the output shaft (45) of the motor gear (5), on the opposite side with respect to the friction wheel (4). Said pulley (500) si positioned between two friction discs (52, 53), for example two discs made of friction material known as Ferodo. In practice, the two sides of the pulley (500) are each in contact with a corresponding friction disc (52, 53). On the external disc (52), that is, the friction disc (52) more distanced from the friction wheel (4), there is a spring (54). The latter is mounted on the shaft (45), coaxially to the same shaft, and is provided with an adjusting screw (55) by means of which the friction exterted by the friction discs (52, 53) on the two sides of the pulley (500) can be adjusted. A fixed plate (8), positioned below this mechanism, is provided is provided with two elements (71) that act as mechanical limit stops for the carriage (7). The friction discs (52, 53) transmit the motion of the shaft (45) to the pulley (500) and, through the belt (51), to the carriage (7) and, therefore, to the blade (6). When the carriage (7) reaches a stop position as further disclosed below, the pulley (500) skids between the discs (52, 53). In this operative condition, the shaft (45) moves the blade (6) only, without moving the carriage (7). In practice, the group formed by the pulley (500) and the friction discs (52, 53) is a device for disengaging the carriage (7) from the motor gear (5) when the carriage (7) reaches a limit stop position. Such a disengaging device allows, in said operative condition, to use the motor gear (5) to operate the friction wheel (4) even if the carriage (7) is stopped. The guide (70) is hinged, with axis parallel to the axis (1a) of the idle wheel (1), to two vertical fixed walls (80) emerging from the base (8) by means of pins (81) orthogonal to the same walls (80). An arm (75), turned towards the exit (E) for the cardboard stripe (S), projects from a side of the guide (70). On said arm there is a spring (72) having a vertical axis and fitted on a corresponding adjusting screw (73) that, at its lower end, is inserted in the base (8). The screw (73) allows the adjusting of the compression or spring (72) and, as a consequence, the adjusting of the pressure exerted by the blade (6). Moreover, on the front end of the arm (75) there is provided another screw (74) whose function is to limit the rotation of the guide (70) about the axis defined by the pins (81). By screwing or unscrewing the screw (74) it is possible to adjust the maximum angular run of the guide (70) about the axis of the pins (81) and therefore it is possible to adjust the distance of the blade (6) from the idle wheel (1). These adjusting systems allow the user to adapt the machine to the varying features (such as thickness, structure etc.) of the cardboard stripes (S) used for making the tubes (T) and to compensate the progressive consumption of the cutting edge of blade (6).

Downstream of the carriage (7) with respect to the dragging direction (TD) there is a group formed by a pluralitgy of wheels (9) mounted on a motorized horizontal shaft (90) that is parallel to the carriage (7). Said wheels (9) and the respective shaft (90) are positioned below the idle wheel (1). Downstream of the wheels (9) with respect to the dragging direction (TD), there is a ramp (91) ending close to the mandrel (M), i.e. ending in said exit station (E).

A protecting cover (12) is provided, to cover the space above the idle wheel (1) and the friction wheel (4).

On a side of the cover (12) there is a concave plate (13), with the concavity turned upwards, that, as further disclosed below, facilitates the execution of the drawing-in step. Said concave plate (13) is fixed, at its convex side, to a front concave edge (82) of a corresponding vertical plate (80).

The machine works as follows.

The operator manually inserts the cardboard stripe (6) in the space (VS) between the idle wheel (1) and the friction wheel (4), as shown by arrows <<F>> in FIG. 1. This operation is facilitated by the plate (13) that acts as a guide. The cardboard stripe (S) is fed by a corresponding unwinder (known per se) provided with supports for supporting a cardboard reel formed by the cardboard stripe. Again grasping the front edge (SA) of the cardboard stripe (S), the operator gives the latter the configuration shown in FIG. 6, that is, he passes the front end of the cardboard stripe (S) between two rollers (R1, R2) provided, at different heights, in front of the cover (12) such that front end of the cardboard stripe (S) results above the mandrel (M). The lower roller (R1) is fixed on the base plate (8) while the upper roller (R2) si fixed to a vertical wall (80). It is noted that in the meantime the winding belt (WB) is stopped, so that this step is executed in a safe condition. With the cardboard stripe (S) thus configured, the operator, making use of a keyboard (P), activates the gluing means and manually pulls the cardboard stripe (S) until he visually notes the presence of the glue (G) that is applied on the upper side of the cardboard stripe (S). Then, the operator, making use of the same keyboard, starts the following automatic procedure. The pneumatic cylinder (3) is activated and, by means of the lever (23), moves the idle wheel (1) towards the friction wheel (4). Consequently, the cardboard stripe (S) is compressed between wheels (1) and (4). A sensor (S1), shown in FIG. 11 only, senses the advanced position of the idle wheel (1) and activates the motor gear (5). Therefore, the friction wheel (4) is actuated and, since it rotates, it drives the cardboard stripe (S) along the drawing-in direction (TD) while the idle wheel (1) freely rotates about its own axis (1a). Now, the operator stops the manual pulling of the cardboard stripe (S). When the rotation of the friction wheel (4) starts, such that the cardboard stripe (S) is drawn by the latter, the carriage (7) is simultaneously moved along the guide (70), since the respective transmission (50, 500, 51) is linked to the same shaft (45) on which the friction wheel (4) is mounted. Therefore, the blade (6) cuts the cardboard stripe (S) while the latter is drawn along the drawing-in direction (TD). As said above, the blade (6) can be positioned with an inclination angle (b) such that the front end of the tube (T) to be formed on the mandrel (M) will be substantially orthogonal to the mandrel axis, thus avoiding a further tube trimming step downstream of the mandrel. When the carriage (7) reaches ist end position, the transmission (50, 500, 51) is disengaged from the shaft (45) as disclosed above. Therefore, while the rotation of the friction wheel (4) continues, the blade (6) is stopped because the carriage (7), in turn, is stopped. Since the friction wheel (4) rotates, the cut portion of the cardboard stripe (S), passing on the wheels (9) and the ramp (91, is pushed towards the mandrel (M), that is, towards the point where the winding belt (WB) is wound on the mandrel. In the meantime, the winding belt (WB) is actuated, therefore the cut portion of the cardboard stripe (S) is catched by the winding belt (WE) that, in a manner per se known, drags it on the mandrel (M) and determines its winding, thus starting the production of the tube (T). After a predetermined tome, the pneumatic cylinder (3) moves the idle wheel (1) in its starting position, that is, in a position distanced from the friction wheel (4) and the motor gear (5), rotating in a direction opposite to the previous one, moves the carriage (7) with the blade (6) to the initial position.

FIG. 7 shows the final step of the cardboard stripe (S) cut, with the front end of the stripe, formed by the cut executed by the blade (6), still in held by the operator.

FIG. 8 shows the formation of the tube (T) on the mandrel (M).

In FIG. 6 and FIG. 8 the idle wheel (1) is distanced from the friction wheel (4), so that the cardboard stripe (S) is drawn by the operator (FIG. 6) or by the winding belt (FIG. 8). On the contrary, in FIG. 7 the idle wheel (1) is approached to the friction wheel (4), so that the cardboard stripe (S) is drawn by the friction wheel (1) because it is pressed between the latter and the idle wheel (1).

It is noted that the friction wheel (4) acts on the non-glued part (NG) of the stripe (S) as shown in FIG. 10.

FIG. 14 shows the rotation directions of wheels (1) and (4) when the cardboard stripe (S) is dragged by the friction wheel (4). The arrow depicted with a solid line denotes the fact that the friction wheel (4) is motorized, while the dashed line arrow denotes the fact that the idle wheel (1) is caused to rotate about the axis (la) by the friction wheel (4).

The motor gear (5), the sensor (S1), the keyboard (P) and the pneumatic cylinder (3) are connected with a control unit (UE) known per se in the field of automation and, therefore, not described in further details.

According to the example disclosed above, the friction wheel (4) and the carriage (7) that supports the blade (6) are driven by a single actuator (5). However, these components can be driven by more independent actuators.

FIG. 15 shows another way of inserting the cardboard stripe (S) that, in this case, is inserted from the above instead of from a side with respect to the dragging means. Therefore, the side guide (13) can be omitted.

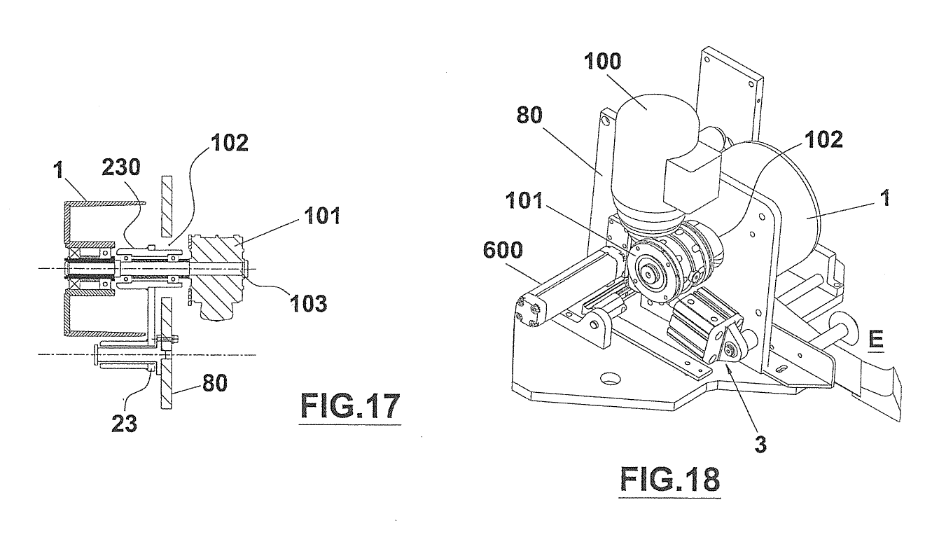

The dragging means could be activated also during the tube formation step thus cooperating with the winding belt (WB) in order to drag the cardboard stripe (S). According to the example shown in FIGS. 16-20, the wheel (1) is motorized, while the friction wheel (4) is free to rotate about its axis. In FIGS. 16.19 the motor that drives the wheel (1) is denoted by the reference number <<100>>. The motor (100) is connected with the wheel (1) by means of a gear transmission (101) whose shaft (103) passes through a hole (102) provided on a side wall (80). The cylinder (3) is mounted on an external side of said side wall and the lever (23), that in the example disclosed above was on the same external side, now is on the inner side, that is, in the space comprised between the inner side of the side wall (80) and the wheel (1). The unit formed by the motor (100) and the gear (101) is provided on a supporting arm (104). The stem of the cylinder (3) and the supporting arm (104) are provided on an end (the lower end in the drawings) of the lever (23). FIG. 17 shows, in particular, the connection (230) of the lever (23) with the shaft (103) and, therefore, with the wheel (1). Consequently, the cylinder (3) acts, through the lever (23), on the wheel (1) and the unit (100, 101) to move the wheel (1) to and from the friction wheel (4). the wheel (1) is a free-wheel, such that it is made to rotate by the motor (100) when the latter is activated (during the drawing-in step) and is free to rotate about its own axis when the shaft (103) is stopped, that is, when the motor (100) is disactivated (at the end of the drawing-in step). Furthermore, the carriage on which the blade (6) is mounted is moved by a pneumatic cylinder (600).

Therefore, according to this example, the means destined to drag the cardboard stripe (S) are mechanically independent with respect to the cutting means.

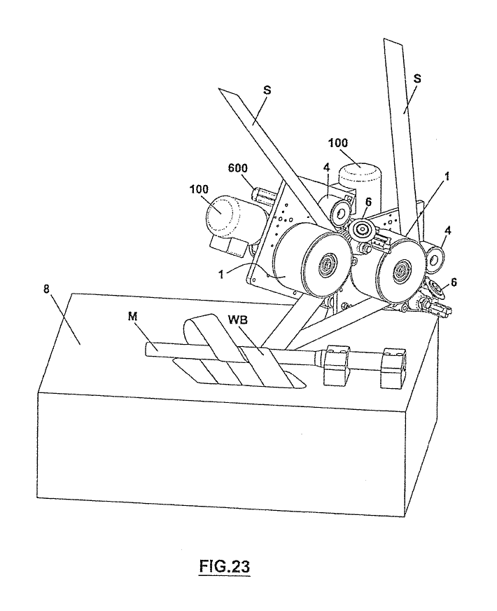

It is understood that a tube forming machine according to the present invention can be provided with a plurality of groups or units formed as disclosed above, whose number equals the number of cardboard stripes (S) for the production of tubes formed by winding a plurality of cardboard stripes on the mandrel (M). According to the example shown in FIGS. 21-23, said groups or units are two in number (U1, U2), for the production of cardboard tubes formed by two cardboard stripes (S). In this example the units (U1, U2) are independent from each other since each of them comprises its own dragging means and cutting means and works one corresponding cardboard stripe (S). The dragging means and the cutting means are those disclosed above. The cardboard stripes (S) are oriented with a same angle with respect to the axis of the mandrel, are partially overlapped at the inlet section (E) and, in order to ovoid their intersection, they reach the mandrel (M) with a different angle of incidence with respect to a plane tangent to the mandrel outer surface (the different angle of incidence of stripes S near the mandrel M is particularly visible in FIG. 23). Therefore, it is possible to execute the drawing-in step in two different ways: the drawing-in step can be executed for a single cardboard stripe (S) at a time, such that the procedure disclosed above is executed two times; alternatively, the operator can draw the two cardboard stripes simultaneously until he notices the glue (that is applied on a cardboard stripe only) and, at this point, he starts the drawing-in step activating both the dragging and cut units, possibly with a delay of the second unit.

In practice the execution details may vary in any equivalent way in relation to the elements described and shown in the drawings, without departing from the adopted solution idea and then remaining within the limits of the protection granted by the present patent.

1. A machine for producing cardboard tubes, the machine comprising:
a mandrel on which a cardboard tube is formed by helicoidal winding of a cardboard strip on said mandrel;
a winding member adapted to interact with said mandrel and said cardboard strip to form said helicoidal winding, said machine being adapted to perform a drawing-in step, said drawing-in step comprising in configuring said cardboard strip in a configuration for winding said cardboard strip on said mandrel, and said machine being adapted to perform a subsequent forming step, said forming step comprising forming said cardboard tube via said helicoidal winding of said cardboard tube;
an inlet section for said cardboard strip to be drawn-in;
a dragging means for dragging said cardboard strip to be drawn-in and introduced in said inlet section, along a predetermined dragging direction, said dragging means being active during said drawing-in step; and
a guide means for guiding said cardboard strip towards said mandrel at an end of said drawing-in step, said guide means being disposed and acting between said dragging means and said mandrel;
a cutting means for cutting said cardboard strip along a cutting direction oriented at a predetermined angle with respect to said dragging direction at said end of said drawing-in step, said dragging means comprising cooperating wheels between which said cardboard strip can be inserted.

2. A machine according to claim 1, wherein said inlet section is on a side of said dragging means.

3. A machine according to claim 1, wherein said guide means comprises a plurality of guide means wheels with a horizontal axis placed below said dragging means, upstream of said mandrel with respect to said dragging direction.

4. A machine according to claim 1, wherein said cooperating wheels comprise two counter-facing wheels between which said cardboard strip can be inserted, said counter-facing wheels comprising axes of rotation, said counter-facing wheels being oriented with said axes of rotation in a direction substantially perpendicular to said dragging direction and said counter-facing wheels being adapted to delimit, between respective counter-facing surfaces, a space of variable volume that in said drawing-in step is greater to facilitate introducing said cardboard strip through said inlet section.

5. A machine according to claim 4, wherein one of said axes of rotation of one of said cooperating wheels is fixed, another one of said axes of rotation of another one of said cooperating wheels being movable toward said one of said cooperating wheels with a fixed axis of rotation and away from said one of said cooperating wheels with said fixed axis of rotation, such that said variable volume of said space between said cooperating wheels can be varied by moving said another one of said cooperating wheels to and from said one of said cooperating wheels.

6. A machine according to claim 5, wherein said another one of said cooperating wheels is an idle wheel and said one of said cooperating wheels is a friction wheel, said friction wheel being covered with material adapted to exert a drag action by friction on said cardboard strip introduced between said cooperating wheels, and said friction wheel being connected to a respective motor member.

7. A machine according to claim 5, wherein said another one of said cooperating wheels is connected with an actuator that moves said another one of said cooperating wheels to and from said one of said cooperating wheels.

8. A machine according to claim 3, wherein said cutting means comprises a blade mounted on a carriage movable in a direction substantially perpendicular to said dragging direction.

9. A machine according to claim 6, wherein a carriage is moved by said motor member, said motor member moving said friction wheel.

10. A machine according to claim 9, further comprising:
a decoupling means positioned and acting between said carriage and said motor member for decoupling said carriage from said motor member.

11. A machine according to claim 1, wherein said guide means comprises a chute provided below said dragging means and upstream of said mandrel with respect to said dragging direction.

12. A machine according to claim 12, wherein said guide means comprises guide wheels, said chute being downstream of said guide wheels with respect to said dragging direction.

13. A machine according to claim 1, wherein said dragging means is inoperative during said forming step.

14. A machine according to any of claims 1-14 claim 1, wherein said dragging means is active during said forming step.

15. A machine according to claim 1, wherein said inlet section is above said dragging means.

16. A machine according to claim 5, wherein said another one of said cooperating wheels is a friction wheel, said friction wheel being covered with material adapted to exert a drag action by friction on said cardboard strip introduced between said cooperating wheels, and said one of said cooperating wheels being an idle wheel, said another one of said cooperating wheels being connected with a respective motor member that causes rotation of said another one of said cooperating wheels during said drawing-in step.

17. A machine according to claim 8, wherein said carriage is moved by a respective individual actuator.

18. A machine according to claim 1, further comprising:
a plurality of operative units, each of said plurality of operative units comprising a respective dragging means for dragging a single cardboard strip during said drawing-in step.

19. A machine according to claim 18, wherein each of said plurality of operative units comprises a respective cutting means for cutting said single cardboard strip at said end of said drawing-in step.

20. A machine according to claim 6, wherein said cutting means comprises a blade mounted on a carriage movable in a direction substantially perpendicular to said dragging direction, said carriage being actuated by said motor member, said motor member moving said friction wheel.
